(19) United States
(12) Patent Application Publication
(10) Pub. No.: US 2006/0043861 A1
(43) Pub. Date: Mar. 2, 2006

(54) Porous glass substrate for field emission device

(76) Inventor: Wei Liu, Painted Post, NY (US)

Correspondence Address: CORNING INCORPORATED, SP-TI-3-1, CORNING, NY, 14831, US

(21) Appl. No.: 10/929,123

(22) Filed: Aug. 27, 2004

(51) Int. Cl. H01J 1/02; H01J 9/04; H01J 1/05

(52) U.S. Cl. 313/311; 313/346 R; 313/310; 313/309; 445/50; 445/51

(57) ABSTRACT

An improved process for growing carbon nanotubes includes steps of providing a glass substrate that has a porous surface, depositing a catalyst into the pores on the porous surface, and growing carbon nanotubes on the substrate. Desirably, the carbon nanotubes are grown using a chemical vapor deposition technique in which the direction of flow of a carbon precursor gas (and any optional diluent gases) is aligned with the desired direction of growth propagation. The techniques of the invention provide a field emission device having more uniformly aligned carbon nanotubes and/or more uniformly sized carbon nanotubes.

### BACKGROUND OF THE INVENTION

1. Field of the Invention

This invention relates to field emission devices, and more particularly to field emission devices comprising carbon nanotubes grown on a glass substrate.

2. Technical Background

The potential advantages of field emission devices, and in particular field emission displays, have been recognized for decades. It has been recognized that field emission displays can achieve a brightness and image quality better than cathode ray tube displays in a flat panel configuration that occupies considerably less space than a conventional cathode ray tube display. This is primarily attributable to the “cold cathode” characteristic of the field emission cathode, in which electrons are emitted from nanoscopic emitters at a considerably lower temperature than the cathode of a conventional cathode ray tube. This allows the cathodes to be placed closer to phosphorescent materials that may be deposited on the inner surface of a display screen, thereby eliminating the need for bulky electromagnetic beam-steering apparatus.

In addition to having advantages over conventional cathode ray tube technology, the field emission displays consume considerably less energy than plasma flat panel displays. The energy requirements for a field emission display are expected to be about one-tenth of the energy requirements of a plasma display of comparable size. Nevertheless, resolution and brightness are expected to be at least comparable to that of plasma displays.

Field emission displays are also expected to have advantages over liquid crystal displays. In particular, field emission displays have a wide viewing angle, whereas liquid crystal displays typically have a very narrow viewing angle.

Field emission devices are based on cold emission of electrons from a matrix array of metal or semiconductor microtips or film emitters. Microtips are small, sharp cones with sharp tips that serve as cathodes. The typical size of the cones is about one micron or less. Initially, field emission displays were made using metal (e.g., molybdenum) cones. However, problems arose during field emission. Specifically, the cathode tips were damaged by local melting, which was compounded by the fact that the electrical resistivity of most metals increases with temperature, creating more heat, which in turn produces a feedback cycle that can destroy the cathodes. Another problem with the metal cathode emitters is that they tend to react with residual gases in a vacuum, which causes degradation of the cathodes, further reducing field emission. Further, processes for fabricating microtips is complicated and costly.

In 1991, Sumio Lijima disclosed the production of carbon nanotubes using arc discharge between graphite rods. A carbon nanotube is a hollow cylindrical structure comprised of SP²-hybridized carbon atoms arranged to form a hexagonal honeycomb-shaped film structure that is arranged in the form of a tube having a diameter of from less than 1 nanometer to about 30 nanometers, and a length up to a few hundred micrometers. It is known that carbon nanotubes have excellent mechanical, electrical and chemical properties for use in field emission devices, such as flat panel displays, special lighting applications, and various vacuum electronic devices (e.g., electronic sensors, microwave amplifiers, vacuum pressure gauges, and electron sources). In particular, carbon nanotubes exhibit excellent field emission properties (e.g., low electron emission threshold and high emission current density), excellent electron conductivity, an electrical resistivity that decreases with increasing temperature thereby preventing destructive heating feedback, excellent thermal stability (e.g., does not melt and does not sublime below about 2500° C.), and is much less reactive than metals thereby reducing gas-poisoning problems.

While it is now understood that carbon nanotubes exhibit outstanding properties for use in field emission devices such as flat panel displays, there has been difficulty controlling the structure of the carbon nanotubes and integrating the carbon nanotubes with other elements to form a field emission device. In a conventional field emission device, an array of nanoscopic (i.e., dimensions of from about 10⁻⁹ meters to about 10⁻⁶ meters) field emission cathodes (emitters) is distributed on the surface of a substrate. The field emission cathodes preferably have a relatively high aspect ratio (i.e., the length of each emitter is at least about 10 times greater than the diameter of the emitter). Desirably, the emitters are uniformly distributed over a surface of the substrate and are preferably aligned with the length direction of the emitters being approximately normal (perpendicular) to the substrate surface. An anode having a generally planar surface is placed in spaced relationship to the tips of the field emission cathodes with the planar surface of the anode being approximately parallel with the substrate surface, and hence approximately perpendicular to the field emission cathodes. It has become apparent that preferred techniques for preparing a field emission device utilizing carbon nanotube emitters involves growing the carbon nanotubes directly on a surface of a substrate that becomes a part of the field emission device, and preferably achieves growth of the nanotubes in a desired pattern or distribution on the surface, with the nanotubes aligned with one another, preferably perpendicular to the substrate surface. Such techniques facilitate growth of a desired pattern having high current density emission, low turn-on voltage, and reduced production costs.

There have been many attempts to develop useful carbon nanotube field emission devices. However, growing an array of carbon nanotubes of high purity exhibiting a high aspect ratio and which are perpendicular to the substrate remains a critical problem that has hindered successful development and commercialization of field emission devices. The nanotubes are often grown on a solid substrate being catalyzed with catalytic metals with a carbon precursor in vapor phase. Side products, such as, polycrystalline graphites, amorphous carbon deposits, etc., have to be minimized during the nanotube deposition.
Desired reaction: Carbon precursor (CO)→carbon nanotubes+byproduct (CO₂)
Un-desired reaction: Carbon precursor (CO)→polycrystalline graphites+byproduct (CO₂) Carbon precursor (CO)→amorphous carbon+byproduct (CO₂)

These reactions are all thermodynamically feasible. Accordingly, there is a need for improved processes and methods that facilitate production of an array of carbon nanotubes having high purity and a high aspect ratio and that may be oriented perpendicular to the substrate, which will facilitate commercialization and widespread use of carbon nanotube field emission products.

### SUMMARY OF THE INVENTION

It has been discovered that the substrate on which the carbon nanotubes are grown is critical to selective synthesis of carbon nanotubes and achievement of uniform nanotube diameter and length, uniform orientation of the nanotube clusters, and good adhesion of the carbon nanotubes to the substrate.

An aspect of the invention relates to the discovery that very substantial improvements in the properties that are critical to field emission performance can be achieved by growing the carbon nanotubes on a porous glass substrate.

In another aspect of the invention, it has been discovered that very substantial improvements in field emission device performance characteristics can be achieved by utilizing a glass substrate comprised of at least 50% silica by weight.

Other objects and features of the invention will become apparent from the following detailed description considered in conjunction with the accompanying drawings. The drawings have been provided solely for the purpose of illustrating certain embodiments of the invention and do not limit the scope of the invention, which is defined by the appended claims.

### BRIEF DESCRIPTION OF THE DRAWINGS

FIGS. 1-3 schematically illustrate preparation of a field emission device in accordance with the invention using a glass substrate that is solid through a portion of its thickness and porous adjacent a surface.

FIGS. 4-6 schematically illustrate preparation of a field emission device in accordance with the invention using a glass substrate having inter-connected pores extending throughout the thickness of the substrate.

FIGS. 7A and 7B are scanning electron micrographs at two different magnifications, which show nanotube growth on CoMo bulk powder in accordance with the comparative Example I.

FIGS. 8A and 8B are scanning electron micrographs, at different magnifications, showing nanotube growth on a CoMo plus silica sol in accordance with comparative Example II.

FIGS. 9A and 9B are scanning electron micrographs, at two different magnifications, showing the result of an attempt to grow carbon nanotubes on CoMo-silica sol in accordance with comparative Example III.

FIGS. 10A and 10B are scanning electron micrographs, at different magnifications, showing the microstructure of a porous glass substrate used in Example IV.

FIGS. 11A and 11B are scanning electron micrographs, at different magnifications, showing carbon nanotubes grown on CoMo-catalyzed porous glass in accordance with Example IV of the invention.

FIG. 12 is a transmission-type electron micrograph showing nanotubes grown out of the catalyzed glass matrix of Example IV.

FIG. 13 is a scanning electron micrograph showing carbon nanotubes grown inside the catalyzed porous glass matrix of Example V.

FIG. 14 is a scanning electron micrograph showing extensive growth of carbon nanotubes on an external surface of a CoMo-catalyzed porous glass of Example VI.

### DETAILED DESCRIPTION OF THE PREFERRED EMBODIMENTS

The field emission devices in accordance with this invention include a plurality of carbon nanotubes attached to a glass substrate. It has been discovered that the field emission characteristics of the device are profoundly affected by the substrate on which the carbon nanotubes are grown. In accordance with an aspect of this invention, the glass substrate has a softening point temperature that is above the chemical reaction deposition process temperature.

More specifically, it is desirable that the glass substrate have a softening point temperature that is above 500° C. In another aspect of the invention, the glass substrate is comprised of at least 50% silica by weight. It has been discovered that silica is a very effective catalyst support for carbon nanotube growth via chemical vapor deposition processes. In accordance with another aspect of the invention, the glass substrate is porous. The porosity of the glass substrate may extend throughout the entire thickness of the substrate, or from a surface through only part of the thickness of the substrate. Suitable pore sizes range from about 1 nm to about 1000 nm, with pore sizes in the range of from about 2 nm to about 100 nm being preferred.

It is believed that, the porous glass substrate enables the catalyst to be anchored inside the pore so that the catalyst does not sinter during nanotube growth, and thus, distinctive nanotubes of a desired diameter may be produced. Specifically, the substrate pore size can be used to control nanotube diameter through affecting the catalyst dispersion or catalyst sizes. The extent of the porosity may also be used to control nanotube density (i.e., the number of nanotubes per unit surface area). Further, the porous glass substrate allows nanotube orientation to be controlled. Nanotube orientation is also affected by the direction of flow of a hydrocarbon precursor gas from a source toward a glass substrate. Specifically, when the reacting gas is introduced in a direction perpendicular to the substrate surface during the growth process, the nanotube may be grown along the flow direction so that an array of nanotubes perpendicular to the surface is formed.

Carbon nanotube growth on a glass substrate consists of three basic steps. Initially, after an appropriate glass substrate has been selected and cleaned, a metal catalyst is deposited on the surface of the substrate. Cleaning of the substrate prior to deposition of the metal catalyst may be achieved using various solvents such as trichloroethylene, acetone and/or methanol, followed by rinsing with deionized water, drying, and calcination. Examples of metal catalysts that may be used include Ni, Pd, Pt, Fe, Ru, Os, Co, Rh, Ir, Cu, Ag, Au, Zn, Cd, Mn, Te, Re, Cr, Mo, W, V, Nb, Ta, Ti, Zr, Hf, Sc, Y, La, and combinations of these metals, including related alloys, compounds or composite films. Preferred metals include Fe, Co, Mo, Ni, Cu, and preferred composites or alloys include CoMo, NiMo, Fe/Mo, Ni/Fe, Ni/Co, Ni/Cr, Ni/Ti, Ni/W, Ni/Si, Ni/Ge, Ni/C, Fe/Co, Fe/Cr, Fe/Ti, Fe/W, Fe/Si, Fe/Ge, Fe/C, Co/Cr, Co/Ti, Co/W, Co/Si, Co/C, Cu/Cr, Cu/Ti, Cu/W, Cu/Si, Cu/Ge, and Cu/C. The catalyst may be deposited on the substrate using any of a variety of known wet chemistry techniques or vapor deposition techniques. Vapor deposition techniques include electron-beam evaporation and magnetron sputtering. An example of a chemical deposition technique is disclosed by Shaoming Huang et al., J. Phys. Chem. B 2003, 107, 8285-8288. In this process, a polymer solution containing a catalyst precursor is printed onto a substrate. Thereafter, the polymer is burned in air at 500 to 600° C. leaving a metal oxide that may be reduced in the presence of a mixture of hydrogen and argon gases as temperature of from about 500 to about 600° C. for from 1 to about 2 hours. In either case, the catalyst may be deposited in a desired pattern specific to a particular application, utilizing known photolithographic and/or printing techniques.

After deposition of the catalyst, carbon nanotubes may be grown on the substrate using any of various well-known nanotube deposition techniques, which include thermal chemical vapor deposition (CVD), plasma enhanced (microwave or radio frequency) CVD, or hot-filament CVD.

The catalyst may also be deposited on the substrate using screen-printing, vacuum arc, pulsed-laser ablation, electroplating, sol-gel chemistry, or electrochemical techniques.

In the chemical deposition processes used for growing the carbon nanotubes on the substrate surface, a stream of carbon precursor gas is directed at the substrate surface. Hydrocarbon precursor gases are typically diluted with hydrogen, nitrogen, argon, helium, neon, or a combination thereof. Examples of suitable hydrocarbon precursors include acetylene, ethylene, propylene, butene, methane, ethane, propane, butane, pentane, hexane, cyclohexane, benzene and toluene. Other suitable precursor gases include carbon precursors such as CO. Thus, the carbon precursor used during chemical vapor deposition for forming carbon nanotubes may be either a hydrocarbon precursor that is pyrolysed during deposition or a non-hydrocarbon, carbon-precursor such as carbon monoxide, which may be mixed with NH₃ gas. The NH₃ gas acts as a catalyst and a dilution gas.

The nanotube growth process via chemical vapor deposition is typically conducted at an elevated temperature, usually about 500° C. or higher. The process is carried out at moderately high pressures (2˜10 bar), at atmospheric pressure or below atmospheric pressure, depending on the catalytic reaction systems.

As is known in the art, the deposition conditions may be controlled to deposit single-wall or multi-wall carbon nanotubes.

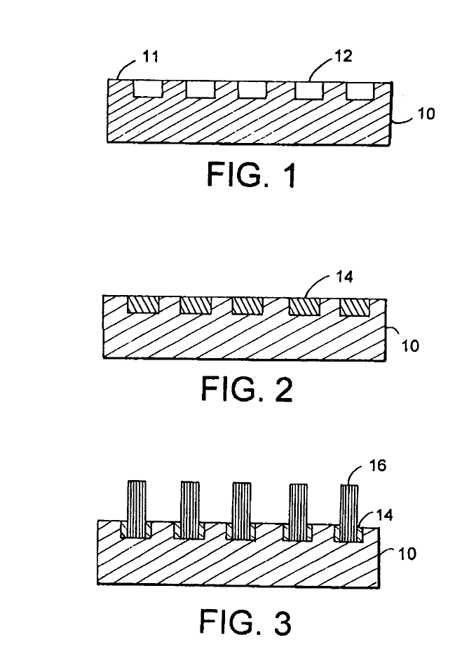

A process in accordance with the invention is schematically illustrated in FIGS. 1-3 for a glass substrate that is generally solid, but includes surface pores or cavities. FIG. 1 schematically illustrates a substrate 10 that is generally solid glass throughout at least a part of its thickness, but includes a surface 11 in which pores or cavities 12 are defined. As shown in FIG. 2, a catalyst 14 is deposited in pores 12 to provide active sites for growth of carbon nanotubes during chemical vapor deposition. FIG. 3 shows carbon nanotubes 16 grown from catalyst 14 deposited in pores 12. The pore confines the catalyst domain and controls the diameter of the carbon nanotube 16. The catalyst 14 and carbon nanotube 16 are stabilized due to enhanced adhesion onto glass substrate 10.

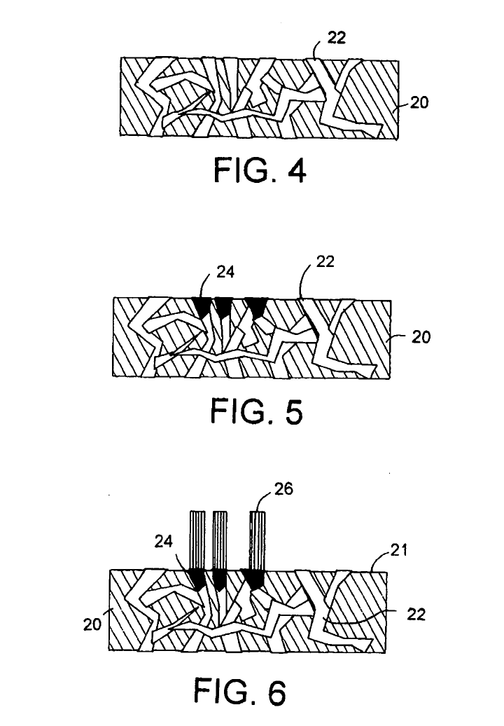

In accordance with another process of the invention, the growth of carbon nanotubes from inter-connected pores or channels extending throughout the thickness of the substrate is illustrated in FIGS. 4-6. Shown in FIG. 4 is a schematic representation of a glass substrate 20 having inter-connected pores or channels 22 extending throughout the thickness of the substrate. The individual channels have a pore diameter of from about 1 nm to about 100 nm. As shown in FIG. 5, catalyst 24 is deposited into pores 22 to provide an active site for carbon nanotube growth during chemical vapor deposition. Carbon nanotubes 26 are grown from the catalyst, as shown in FIG. 6. Growth propagation of the carbon nanotubes 26 is in a direction opposite to the direction of gas flow. Pores 22 on surface 21 of substrate 20 confine and stabilize catalyst 24 and carbon nanotubes 26. The networked pores allow introduction of a feed gas stream in a direction perpendicular to the surface during nanotube growth. Carbon nanotubes 26 only grow on the catalyzed spot and may be lengthened along the flow direction. The carbon nanotube orientation is therefore controlled by the direction of flow of the carbon precursor gas.

### EXAMPLE I

### Comparative Example—Nanotube Growth on CoMo Bulk Powder on Solid Glass

Cobalt(II) molybdenum oxide, CoMoO₄, 99.9% (metal basis), from Alfa Aesar, was used to test the activity of CoMo catalyst alone for carbon nanotube growth. A thin layer of the solid powder was gently distributed on a high purity fused silica glass (Corning's HPFS® fused silica glass marketed under glass code 7980) surface. The HPFS glass is a dense material and has a high melting point. The glass slide was placed in a flow reactor apparatus made of quartz tube of about 19 mm inner diameter. The quartz tube reactor was heated by a three-zone Lindberg furnace. The growth conditions and procedure consisted of (1) calcining the catalyst sample in flowing air by raising the temperature to 250° C. at 2° C./min. in flowing air and holding overnight at 250° C. in the flowing air, (2) purging the reactor tube with inert nitrogen gas for about 10 min., (3) reducing the catalyst in flowing 10% H₂ /Ar gas by raising the temperature to 450° C. at 2° C./min. and holding for 2 h at 450° C., (4) switching the H₂/Ar gas flow to the inert N₂ gas flow, and raising temperature to 700° C. at 5° C./min., (5) switching the inert gas to the 25% CO/Ar gas at 700° C. and conducting the reaction at 700° C. for about 4 h, and (6) switching to the inert gas and letting the reactor cool down.

In the above procedure, calcination removes any volatile organic materials inside the reactor system. In the reduction step, the metal oxide precursor is converted into the metallic catalyst in situ. The carbon nanotube growth occurs in the presence of CO.

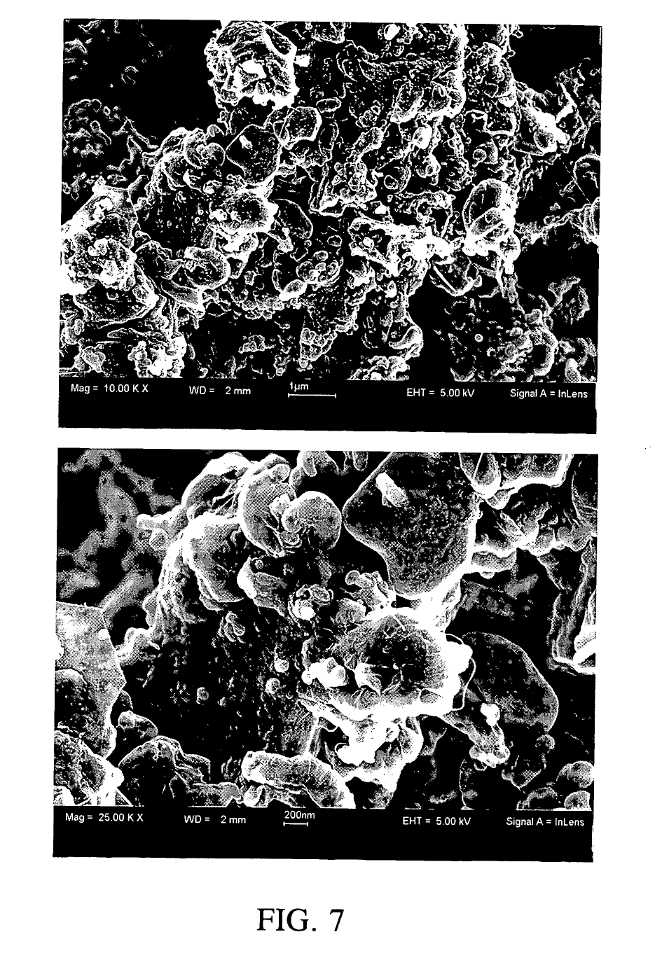

After the reaction in the CO/Ar gas, a layer of black powder was loosely set on the HPFS glass substrate. No attachment to the glass surface was visibly seen. The black powder was analyzed with SEM. As shown in FIG. 7, the material comprises agglomerates of particles in μm sizes. The X-ray probe analysis showed those particles consisting of Co and Mo. Some carbon nanotubes are sparsely distributed among the CoMo particles. However, the carbon nanotubes do not grow on the bulk metallic catalyst surface.

### EXAMPLE II

### Comparative Example—Nanotube Growth on CoMo+Silica Sol on Solid Glass

4 grams of the CoMoO₄ powder as used in Example I were added into 20 gram of silica colloidal solution, 4 nm of silica particle size, 15 wt. % silica in water, from Alfa Aesar. The mixture was vigorously stirred about 30 min. The mixed solution turned a greenish color. The mixture was left overnight for sedimentation of the larger particles. The solution was spread onto the solid HPFS glass surface as used in Example I. The glass slide was placed inside a quartz tube reactor and reacted with the 25% CO/Ar gas at 650° C. for 32 h. The procedure and other conditions were the same as in Example I.

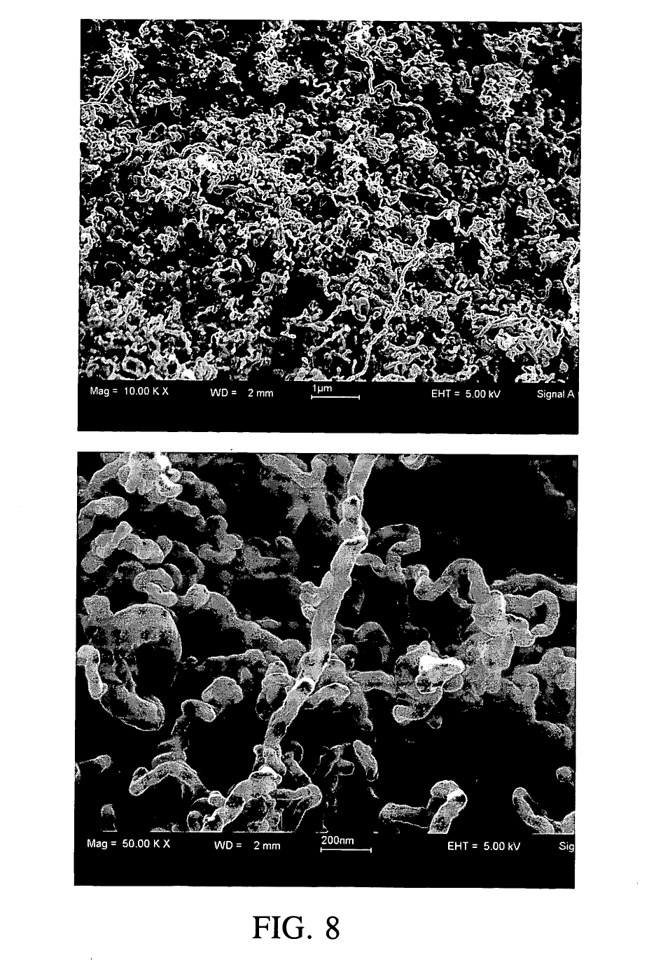

The top layer made of black powder-like material was peeled off from the HPFS glass substrate. No attachment to the glass surface was visibly seen. The black powder was analyzed with SEM. As illustrated in FIG. 8, massive carbonaceous deposition was found. Those materials looked like graphitic fibers and amorphous carbon.

### EXAMPLE III

### Comparative Example—CoMo-Silica Sol on Solid Glass

Sol gel method is used in this example for deposition of catalytic materials on a dense, solid glass surface. The glass substrate (Corning's LCD glass marketed under glass code 1737) was about 0.9 mm thick, dense, and had a smooth surface designed for liquid-crystal display (LCD) application. 7.7 cc of an aqueous solution with concentration of 0.5M Co and 0.5M Mo, was mixed with 35 cc of tetraethoxysilane (TEOS) solution (Aldrich). The two phases were not miscible. 1.4 cc of 30 wt. % HCl solution were gradually added into the mixture. The solution was mixed for about 30 min. under stirring. A clear sol of blue was formed. The sol solution was used to dipcoat a glass slide designed for the LCD application. The glass surface was smooth and dense. The glass slide was placed inside a quartz tube reactor and reacted with the 25% CO/Ar gas at 700° C. for 2 h. The procedure and other conditions were similar to those in Example I.

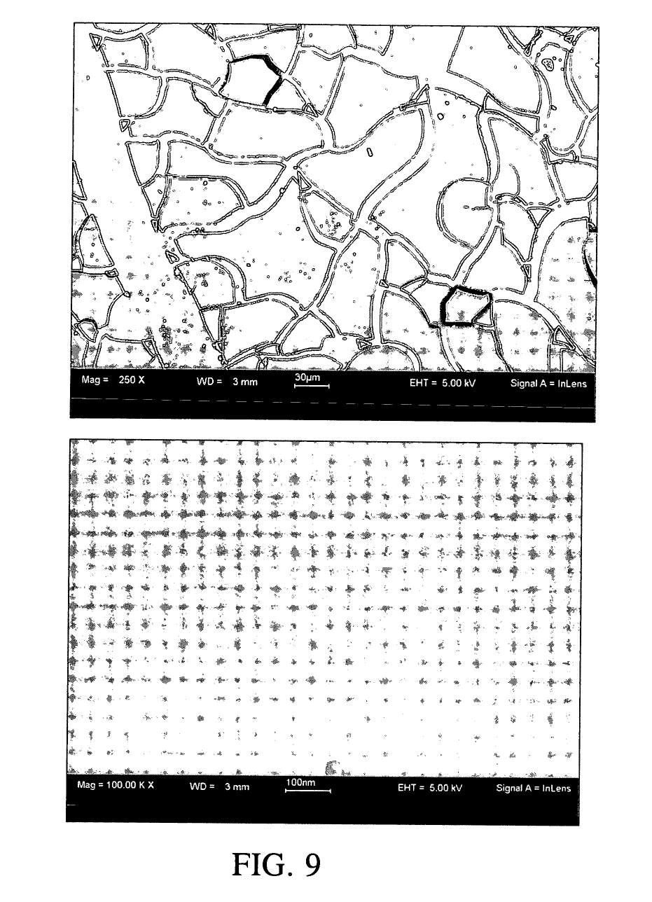

The resulting slide was analyzed by SEM. FIG. 9 shows that the CoMo/silica catalyst layer is still attached onto the glass substrate but there are many cracks. Further analysis of the catalyzed surface showed absence of the carbon nanotube structures on the surface.

### EXAMPLE IV

### Inventive Example—CoMo-Catalyzed Porous Glass

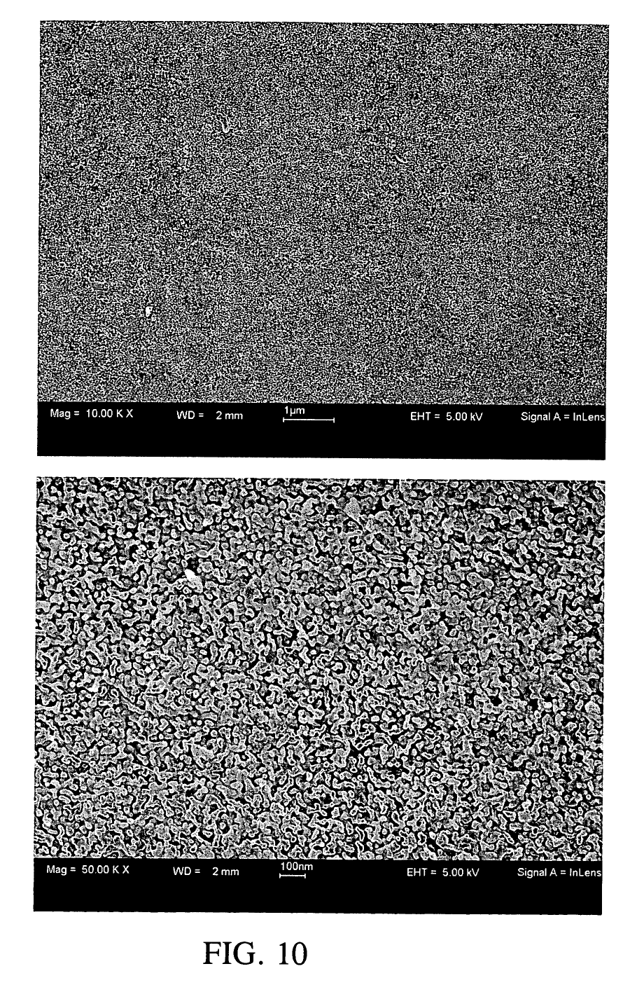

Porous Vycor® glass slides (Corning) were used in this example. The glass composition is 96% SiO₂, 3% B₂O₃, 0.4% Na₂O, and <1% R₂O₃+RO₂ (R=mostly Al₂O₃ and ZrO₂). The Vycor® glass has coefficient of thermal expansion (CTE) of 7.5, softening point temperature of 1530° C., anneal point of 1020° C., and strain point of 890° C. The microstructure of the porous glass substrate is shown in FIG. 10. The average pore size of about 5 nm. The bare glass slide of 1 mm thickness was impregnated with an aqueous solution with concentration of 0.5M Co and 0.5M Mo. The solution was prepared by dissolving cobalt(II) nitrate hexahydrate 98% ACS regeant (Aldrich) and ammonium heptamolybdate tetrahydrate ACS reagent (Aldrich), into de-ionized water. The glass slide was placed inside a quartz tube reactor and reacted with the 25% CO/Ar gas at 700° C. for 2 h with the procedure and conditions same as used in Example III.

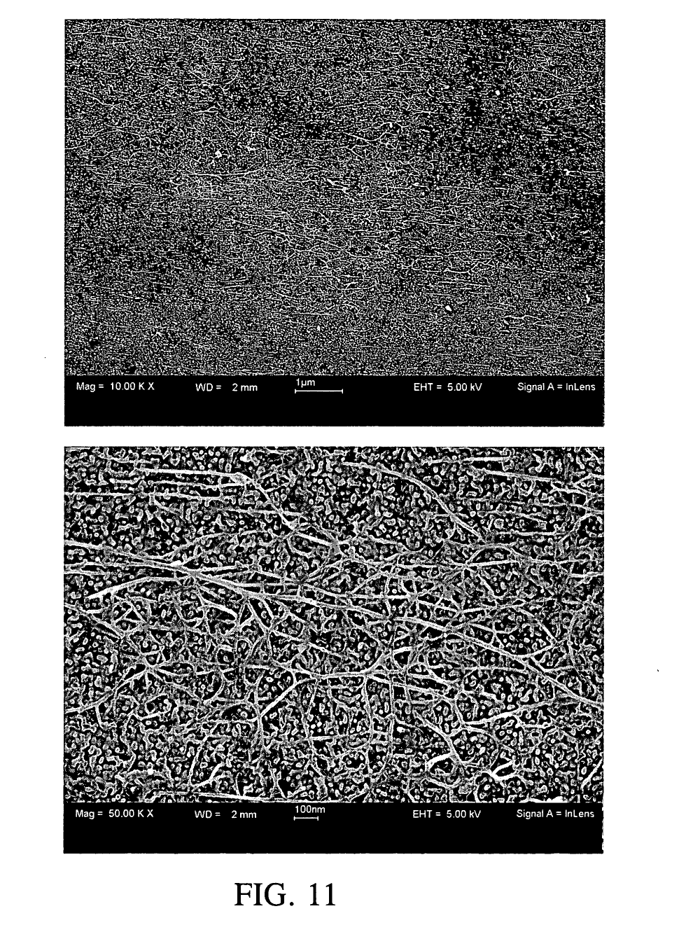

The resulting sample was analyzed with SEM. FIG. 11 shows massive growth of nearly uniform diameter of carbon nanotubes on the glass surface. Compared to the Comparative Examples I, II, and III, in figures, this example clearly shows the effectiveness of porous glass substrate for carbon nanotube growth.

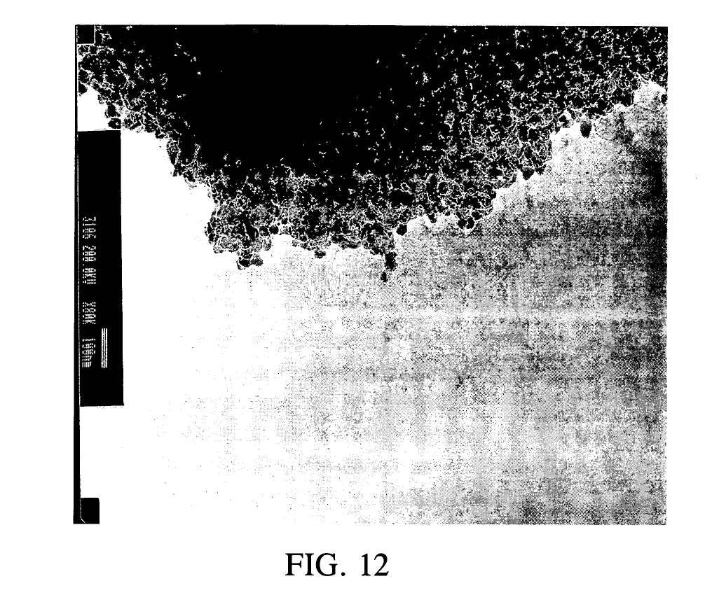

The structure was further analyzed by the XPS and TEM method. FIG. 12 shows the TEM micrograph of nanotubes grown out of the catalyzed glass matrix. The catalyst was dispersed so well within the porous glass substrate so that no large catalyst particles were seen.

### EXAMPLE V

### Inventive Example—CoMo-Catalyzed Porous Glass

A porous Vycor glass slide similar to what was used in Example VI was immersed inside an aqueous solution with concentration of 0.5M Co and 0.5M Mo under vacuum. The vacuum helped penetration of the metal solution inside the glass. The glass slide was placed inside a quartz tube reactor and reacted with the 25% CO/Ar gas at 700° C. for 2 h with the procedure and conditions same as used in Example IV.

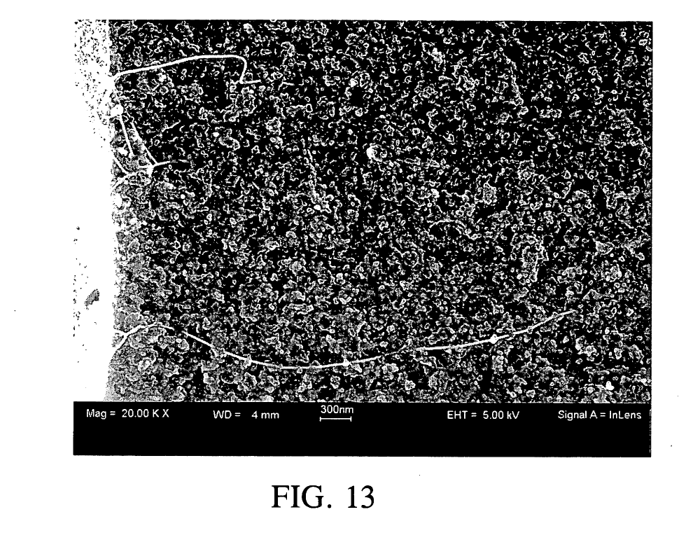

FIG. 13 shows that long, carbon nanotubes can grow inside the catalyzed porous glass matrix.

### EXAMPLE VI

### Inventive Example—CoMo-Catalyzed Porous Glass

A porous Vycor glass slide similar to what was used in Example VI was dipped into an aqueous solution with concentration of 0.5M Co and 0.5M Mo. The excessive solution on the glass external surface was removed by spinning motion. The glass slide was placed inside a quartz tube reactor and reacted with the 25% CO/Ar gas at 700° C. for 2 h with the procedure and conditions same as used in Example IV.

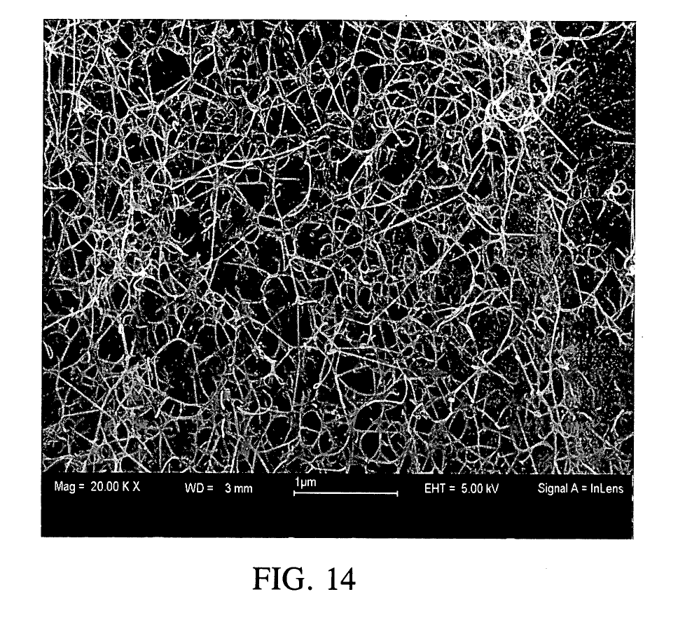

FIG. 14 shows extensive growth carbon nanotubes on the external surface. The carbon nanotube shows good purity, since large graphite flakes or amorphous carbonaceous deposits were not seen.

The above-noted examples clearly show the surprising, dramatic impact of the glass substrate on the carbon nanotube growth with the same catalyst material (CoMo) and same carbon precursor (CO). The substrate does not serve barely as a physical support. It is believed in this invention that the glass substrate chemically and physically interacts with the catalyst and in turn, determines the carbon nanotube growth. The porous glass substrate with high silica content was found to be an effective catalyst substrate to grow carbon nanotubes of high purity. The porous structure enables growth of carbon tubes inside the glass and outside the glass as well. The nanotubes grown on this kind of support are fairly stable and resistant to incidental scratching or scrubbing.

It is noted that the catalyst was added onto or into the porous glass substrate by the wet chemistry technique for illustrative purposes. The catalyst can be deposited on the substrate of present invention by any other means, physical vapor deposition, chemical vapor deposition, etc.

It will become apparent to those skilled in the art that various modifications to the preferred embodiment of the invention as described herein can be made without departing from the spirit or scope of the invention as defined by the appended claims.

The invention claimed is:

1. A field emission device, comprising:
a glass substrate having a porous surface; and
a plurality of carbon nanotubes attached to the porous surface of the glass substrate.

2. The field emission device of claim 1, wherein the glass substrate comprises at least 50% silica by weight.

3. The field emission device of claim 1, wherein the glass substrate has a softening point temperature above 500° C.

4. The field emission device of claim 1, incorporated into a flat-panel display.

5. The field emission device of claim 1, wherein the pores of the porous surface have an average size of from 1 nm to 1000 nm.

6. The field emission device of claim 1, wherein the pores of the porous surface have an average size of from 2 nm to 100 nm.

7. The field emission device of claim 1, wherein the pores extend throughout the thickness of the substrate.

8. A field emission device, comprising:
a glass substrate comprising at least 50% silica by weight and having a porous surface with an average pore size in the range of from 1 nm to 1000 nm; and
a plurality of carbon nanotubes extending from the porous surface of the glass substrate.

9. The field emission device of claim 8, wherein the glass substrate has a softening point temperature above 500° C.

10. The field emission device of claim 8, incorporated into a flat-panel display.

11. The field emission device of claim 8, wherein the pores of the porous surface have an average size of from 2 nm to 100 nm.

12. A process for making a field emission device, comprising:
providing a glass substrate having a porous surface;
depositing a metal catalyst on the porous surface of the glass substrate; and
growing carbon nanotubes on the porous surface of the glass substrate.

13. The process of claim 12, wherein the glass substrate comprises at least 50% silica by weight.

14. The process of claim 12, wherein the glass substrate has a softening point temperature above 500° C.

15. The process of claim 12, wherein the pores of the porous surface have an average size of from 1 nm to 1000 nm.

16. The process of claim 12, wherein the pores of the porous surface have an average size of from 2 nm to 100 nm.

17. The process of claim 12, wherein the pores extend throughout the thickness of the substrate.

18. A process for making a field emission device having uniformly oriented carbon nanotube emitters, comprising:
providing a glass substrate comprising at least 50% silica by weight;
depositing a metal catalyst on a surface of the glass substrate; and
growing carbon nanotubes in a desired orientation using a chemical vapor deposition technique by directing a flow of a carbon precursor gas from a source toward the substrate in a direction with respect to the substrate that coincides with the desired orientation of the carbon nanotubes.

19. The process of claim 18, wherein the glass substrate has a softening point temperature above 500° C.

20. The process of claim 18, wherein the pores of the porous surface have an average size of from 1 nm to 1000 nm.

21. The process of claim 18, wherein the pores of the porous surface have an average size of from 2 nm to 100 nm.

22. The process of claim 18, wherein the pores extend throughout the thickness of the substrate.
